(19) United States
(12) Patent Application Publication
(10) Pub. No.: US 2007/0031321 A1
(43) Pub. Date: Feb. 8, 2007

(54) Apparatus and method for purification of corrosive gas streams

(76) Inventors: Daniel Alvarez JR., San Diego, CA (US); Daniel A. Lev, Chicago, IL (US); Jeffrey J. Spiegelman, San Diego, CA (US); Tram D. Nguyen, Westminster, CA (US); Russell J. Holmes, Santee, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/559,070

(22) PCT Filed: Jun. 23, 2004
(86) PCT No.: PCT/US04/20120

§ 371 Date: Aug. 14, 2006

Related U.S. Application Data
(60) Provisional application No. 60/480,709, filed on Jun. 23, 2003.

(51) Int. Cl. C01F 11/22; C01F 5/28

(52) U.S. Cl. 423/490; 423/210

(57) ABSTRACT

A process, composition and apparatus for the removal of impurities from corrosive gases, particularly halogen-containing gases, down to about 100 ppb concentration are described. The critical component is zirconia (ZrO₂), which in a variety of physical forms is capable of dehydrating such gases. The zirconia can be in the form of a coating on a substrate, as a granular bulk material, or deposited within the pores of a porous body. The zirconia is retained in a simple container which is easily installed in a gas supply line, such as to a gas- or vapor-deposition manufacturing unit. The purification process can be operated for long periods of time in the presence of these gases. The invention provides final purification to gas streams intended for gas- or vapor-deposition formation of high purity electronic, prosthetic or similar products, and can be used in combination with a preliminary dehydration process or a solid particulate removal unit upstream.

### RELATED APPLICATIONS

This application claims the benefit of U.S. Provisional Application No. 60/480,709, filed on Jun. 23, 2003. The entire teachings of the above application are incorporated herein by reference.

### BACKGROUND OF THE INVENTION

Water is one of the most common and yet most difficult impurities to remove from gases, if unwanted. Water is of course ubiquitous in almost all ambient environments. Even systems which are nominally referred to as “dry” usually have significant amounts of water, and most drying processes can reduce the moisture content of a gas only to a “minimum” which is still in the parts per million (ppm) range. However, since for many purposes water contents in the ppm range are quite acceptable, there are numerous patents and articles in the literature dealing with such types of “ppm drying processes.”

In the manufacture of many electronic products, such as high purity wafers, chips, integrated circuits or ceramics, however, moisture contents of depositing gases in the ppm range are too wet. Further, there are a number of gases used in the manufacture of high purity products which in the presence of water become highly corrosive to manufacturing system equipment. Corrosion in turn causes gas leaks and component failures in valves, regulators, filters, flow controllers, tubing and fittings. Among the most common gases which are aggressive and corrosive when they have a high moisture content are the halogen gases, such as the hydrogen halides and the gaseous halides. The halogen gases have been found to be excellent silicon etchants, and therefore it is important to ensure that they can be used effectively in the production of the high purity products.

The corrosive effect of the halogen gases in the presence of water not only causes damage to the equipment, it also is detrimental to the products being made therefrom. The water content itself causes problems in product integrity and yield. In addition, the gas-induced corrosion of the equipment, tubing, etc., generates small particles of corroded materials. These become entrained in the gas stream and are carried into the product formation chambers, where they deposit onto products being formed, thus ruining the products and decreasing yield.

Current technologies are not compatible with liquid phase corrosives. Attempts to use silica, alumina, titanium tetrachloride, and other oxides, halides, etc. to remove moisture from corrosive gases, e.g. halogen-containing gases, have not been successful. While corrosive halogen-containing gas streams can be dehydrated for short periods of time down to the 100 ppb level, the corrosive effects of the halogen gases very quickly damage and deactivate the active dehydration materials requiring frequent removal and replacement of the dehydration materials in order to ensure a feed stream of dried halogen-containing gases in the manufacturing systems.

Gases that are commonly considered corrosive are generally only corrosive in the presence of water. It is necessary to remove water from these gases to eliminate corrosion of the components of delivery systems and manufacturing devices. It is especially desirable to dehydrate the corrosive gases as close to the source as possible to protect components downstream of the source. The most advantageous placement of a purification device in a corrosive gas delivery system is immediately downstream of the source. Regulators, which are typically placed directly downstream of the source to control the pressure in the system, are particularly susceptible to wet corrosive gases, because the high pressure differential leads to Joule-Thompson condensation of moisture. Condensed moisture is extremely detrimental in an ultra high purity corrosive gas delivery system. However, purification devices immediately downstream of the corrosive gas source are susceptible to high pressures and high flow rates that are often in the liquid regime of the phase diagram. Furthermore, certain corrosive gases with relatively low vapor pressure, e.g., HBr, Br₂, and SiCl₄, often liquefy in the purification device. Therefore, it is highly desirable for a corrosive gas purification device to be tolerant of high pressure, high flow rate, and liquid phases. Most purification technologies currently available for use with corrosive gases do not satisfy the requirements necessary to be placed immediately downstream of the source and are incompatible with liquid phases. The devices that are available for use under these conditions do not maintain their performance over a long period of time.

High silica zeolites, such as mordenite, have been taught for the removal of moisture from corrosive gases (see U.S. Pat. No. 5,910,292). Such zeolites were found to be effective in the removal of water from halogen gases to 100 ppb or lower. It is believed that reduction of alumina from the zeolite such that the ratio of silica to alumina is at least 20:1 makes the material more stable by reducing the amount of alumina that is capable of reacting with the halogens and halides of the gas stream. This decreased reactivity results in a material with higher stability that can be used effectively in a dehydration apparatus. Superheated zeolites, specifically mordenite have also been used for the dehydration of corrosive gases (U.S. Pat. No. 6,395,070). Such materials work well initially, but are susceptible to degradation over time (approximately 6 months to a year).

Carbon based salt compositions and carbon and silica gels impregnated with MgCl₂ for dehydration of corrosive gases have also been taught. Superheated carbon has also been used as a dehydrating agent with corrosive gases (U.S. Pat. No. 6,547,861). However, such materials are not highly versatile and may only be used with a selection of halide gases. These dehydration agents are also susceptible to degradation over time and can release volatile byproducts when they decompose. Additionally, the dehydration agents cannot be regenerated, which is an important process that reduces environmental waste and increases process efficiency.

Consequently, the problem of removal of moisture down to 100 ppb from corrosive chlorine-containing gases remains a significant problem in many fields. Those processes which are being used are expensive often because of the very short service life of the dehydrating materials and the need for their frequent replacement. In addition, since it is difficult to determine the exact rate of deterioration of the dehydrating materials in the presence of the corrosive halogen and halide gases, users of such dehydrating materials must schedule their discard and replacement at intervals less than the shortest expected service life.

### SUMMARY OF THE INVENTION

We have now developed a unique and highly effective process for the removal of impurities from corrosive halogen-containing gases, using zirconia as a dehydrating material. This process can be used in the gas supply lines in gas or vapor deposition manufacturing equipment. This process is compatible with and operative in the liquid phase of the corresponding corrosive gases. Thus, as used herein, “corrosive gases” refer to both gas phase and the liquid phase of the same gas.

We have discovered that zirconia (ZrO₂) in a variety of physical forms can be used very effectively to reduce water content of halogen-containing gases down to, in one embodiment, not more than about 100 ppb, in another embodiment, down to not more than about 50 ppb, in another embodiment, down to not more 10 ppb, in another embodiment, down to not more 1 ppb. This dehydration process can be operated for long periods of time in the presence of these gases, since the zirconia used is not susceptible to corrosion by halogenated gases. The invention also includes the unique compositions and their various configurations as used in this process, as well as the apparatus for containing the compositions, and which is adapted to be mounted in a gas conduit delivering the gas or vapor to a gas or vapor deposition chamber.

In one embodiment, the present invention is a method of removing water from a stream of corrosive gas. Examples of corrosive gases include HX, X₂, BX₃, GeX₄, SiX₄ and SiHₐX₍₄₋ₐ₎, where X is a halogen, such as F, Cl, Br or I and a is 0, 1, 2, 3 or 4. The method comprises passing the gas stream over or through a quantity of zirconia for a period of time sufficient to reduce the water content of the gas stream to not more than 100 ppb, said zirconia being substantially unaffected by the corrosive gas. In one embodiment, the water content of the gas stream is reduced to not more than 10 ppb. In another embodiment, the water content of the gas stream is reduced not more than 1 ppb.

In one embodiment, zirconia is impregnated with a metal oxide selected from metal oxides of Groups 1, 2, 3, 4 or 5. In some embodiments, the metal oxide is selected from the group consisting of MgO, CaO, SrO, BaO, Li₂O, Na₂O, K₂O, Sc₂O₃, Y₂O₃, HfO₂, V₂O₅, Nb₂O₅, Ta₂O₅, La₂O₃ and CeO₂. In one embodiment the metal oxide is MgO.

In further embodiments, the method further comprises activating the metal oxide impregnated zirconia to reduce said metal oxide for a period of time until the moisture released is sufficiently low before the corrosive gas stream is passed over or through a quantity of zirconia. In one such embodiment a purification material that comprises zirconia as the majority component is subjected to a reducing gas stream composed of 5% hydrogen in argon at a temperature between about 150-500° C.

In one broad embodiment, the invention is of a method of removing impurities from a stream of corrosive gas which comprises passing the gas stream over or through a quantity of a purification material that comprises zirconia for a period of time sufficient to reduce the impurity content of the gas stream. In various embodiments in which water is a particularly detrimental contaminant, the water content of the gas stream is reduced to not more than 100 ppb, 50 ppb, 10 ppb, or 1 ppb. Other critical impurities removed by the practice of the invention include but are not limited to volatile metals compounds. Specifically volatile metals, e.g., TiCl₄, AlCl₃, and CrF₅, are removed to less than 10 ppb, preferably less than 1 ppb. The zirconia employed remains substantially unaffected by the corrosive gas or liquid.

In a further embodiment of the present invention, the purification material that has become saturated with impurities such that it no longer removes those impurities to the specified levels is capable of being regenerated for reuse in the same purification method. Regeneration is a process in which the material is returned to an active state and has been previously described for a number of purification materials. However, the present invention is the first example of a corrosive gas purification material that is capable of being regenerated for reuse in the same process.

The zirconia may be in the form of a porous solid body, in the form of a plurality of granular particles, in the form of a high surface area solid material, or deposited within the pores of a porous solid material. Purification of the gas stream occurs as the gas stream is passed through or over zirconia or solid material that comprises zirconia.

In another embodiment, the present invention is an apparatus for purifying a stream of corrosive gas. The apparatus comprises a container comprising a gas-tight chamber therein and zirconia, disposed within the gas-tight chamber. The container further comprises a gas inlet port and a gas outlet port penetrating the container and providing fluid communication for flow of the corrosive gas into the chamber from the exterior of the container and out of the chamber to the exterior of the container. In the embodiments where the impurity being removed is water, zirconia is provided in a quantity sufficient to reduce the water content of the stream of corrosive gas to not more than about 100 ppb as the corrosive gas passes through the chamber where it contacts zirconia. During the operation of this device, the zirconia within the chamber remains substantially unaffected by the corrosive gas. The container itself can be made of a halogen-resistant metal or can be described to have a halogen-resistant lining, so that the housing itself is not susceptible to corrosion and thus does not become the limiting factor in the service life of the system.

### BRIEF DESCRIPTION OF THE DRAWINGS

FIG. 1 is an oblique view, partially cut away, of a canister for containment of the zirconia dehydration material for use in this invention.

FIG. 2 is a schematic sectional view illustrating alternatively a porous body of zirconia or sheets of zirconia in which the halogen- and moisture-containing gases contact the zirconia and are dehydrated as they pass through the porous body or over the sheets, respectively.

FIG. 3 is a block diagram illustrating the use of the present invention in a gas dehydrating system for a gas- or vapor-deposition manufacturing process.

### DETAILED DESCRIPTION OF THE INVENTION

The present invention is based on the discovery that electropositive, oxophilic, and corrosion resistant properties of zirconia (ZrO₂) make it a superior purification agent for removal of impurities from corrosive gas and liquid streams, notably halogen-containing or halide gas streams, for extended periods of time without itself being corroded and deteriorated by the presence of the halogen. Water is generally considered to be an exemplary impurity in corrosive gases and liquids, because the corrosive property is dependent on the concentration of moisture in the gas or liquid.

It will be recognized that “effectiveness” for the purpose of the invention means the ability to remove sufficient impurity from the gas stream so that the residual impurity content of the treated gas after contact with the zirconia or other materials of the present invention in the purification device falls below a desired level. While water is the most common and ordinarily the most damaging contaminant in corrosive gases and liquids, other contaminants are known to be detrimental to the processes that use corrosive gases. In particular the volatile metal compounds, especially the transition metal halides, are critical impurities in the semiconductor processes, such as deposition and etching. Examples of volatile metal compound contaminants that are known to reside in corrosive gas streams are TiCl₄, AlCl₃, and CrF₅. Therefore, in one embodiment of the present invention metal impurities are removed from a corrosive gas stream to less than 10 ppb, preferably less than 1 ppb, more preferably less than 0.1 ppb.

With respect to the dehydrating embodiments of the present invention, the residual water content of a corrosive gas stream is not more than about 100 ppb, in another embodiment, down to not more than about 50 ppb, in another embodiment, down to not more 10 ppb, in another embodiment, down to not more ppb.

A purification material's mere ability to reduce impurity content to a desired level is not sufficient for usage; the material must also be sufficiently resistant to halogen or halide corrosion that it can be used for extended service periods. For example, where water is an impurity, the device of the present invention can operate for at least 24 months of maintaining 100 ppb moisture content (or less, usually significantly less) in the exit gases. Our invention resides in the discovery that zirconia can be used in this respect.

The methods of the present invention employ zirconia alone or in combination with oxides of Zr-like metals of Group 3, Group 4, Group 5, such as oxides of Ti, Hf, V, Nb, Ta, and La or the Lanthanide metals. “Zr-like metals” are defined herein as metals of Groups 3, 4 or 5, or Lanthanides that are highly electropositive and form oxides that are resistant to corrosion and that have high surface areas that are retained during heating.

A number of oxides of Zr-like metals can be used in the invention including, but not limited to Sc₂O₃, Y₂O₃, TiO₂, HfO₂, V₂O₅, Nb₂O₅, Ta₂O₅, La₂O₃, CeO₂ and other oxides formed with elements from Group 3, Group 4, Group 5, and the Lanthanide series. Up to and including 25% by weight of the purification material can be comprised of a material other than zirconia, preferably up to 10%, more preferably up to 5%. As used herein, the Zr-like metals will collectively be referred to as “dopants” and the term “doped zirconia” will be understood to mean zirconia containing a minority component of one or more dopants.

In other embodiments, zirconia or doped zirconia can be used in combination with metal oxides of Groups 1, 2 and 3. Oxides of Groups 1, 2 and 3 can be used to augment the removal of water from a stream of corrosive gas because, due to their ionic binding properties, these oxides readily react with water. The metal oxides that can be used include but are not limited to magnesium oxide (NgO), calcium oxide (CaO), strontium oxide (SrO), barium oxide (BaO), lithium oxide (Li₂O), sodium oxide (Na₂O), potassium oxide (K₂O), sandium oxide Sc₂O₃, yttrium oxide Y₂O₃, and lanthanum oxide La₂O₃, as well as lanthanide oxides (LnOₓ) such as CeO₂.

All Group 1, 2 and 3 metals that are capable of reacting with a halide, and are easily converted to hygroscopic salts can be used. The preferred method for doping these salts onto the zirconia or doped zirconia is by impregnation from a solution containing a reactive precursor of the salt. However, the method of doping is not a limitation of the present invention and a number of methods are know to those skilled in the art, including but not limited to incipient wetness and sublimation.

The purification material comprising zirconia has a surface area of not less than about 10 m² per gram (m²/g), preferably greater than about 50 m²/g, more preferably greater than about 100 m²/g. High surface area partially reduced materials comprising zirconia as a major component are difficult to produce. In one embodiment of the present invention dopants, i.e., non-zirconium additives, are intimately mixed with the material by methods known to those skilled in the art, e.g., coprecipitation, cation exchange, and sol-gel synthesis. Said dopants increase the surface area and high temperature stability of the purification materials without diminishing the purification performance and compatibility with corrosive gases. Preferred dopants for use in the present invention include, but are not limited to Ca, Mg, Si, Sc, Y, Hf, V, Nb, Ta, La, Ce, and Pr. In the method of the present invention the total dopant concentration does not exceed about 25%, preferably is less than about 10%, and more preferably about 5%.

The surface area of the dehydrating material of the present invention can be determined by the Brunauer-Emmett-Teller method (BET method). Briefly, the BET method determines the amount of an adsorbate or an adsorptive gas (e.g., nitrogen, krypton) required to cover the external and the accessible internal pore surfaces of a solid with a complete monolayer of adsorbate. This monolayer capacity can be calculated from an adsorption isotherm by means of the BET equation and the surface area is then calculated from the monolayer capacity using the size of the adsorbate molecule.

In a preferred embodiment of the instant invention, the zirconia is impregnated with magnesium oxide (MgO). One method of forming the substrate is generating a suspension of insoluble zirconium oxide (ZrO₂) in a saturated solution of magnesium acetate [Mg(OCOCH₃)₂] in water. The reagents combine to form MgO/ZrO₂ which settles out of solution and is collected by filtration. The mixture is dried overnight or up to 24 hours at about 150° C. and then heated to about 400° C. for 15 hours. One embodiment of a method for formation of the substrate is detailed in Example 1.

For purposes of this invention, “halogen-containing gases” may be defined as those gases in which the predominant component is a gaseous halogen, a gaseous hydrogen halide, a comparable gaseous compound containing an active halide moiety, or a gas having equivalent corrosion properties in the presence of water. Principal examples include HX, X₂, BX₃, GeX₄, SiX₄ and SiHₐX₍₄₋ₐ₎, where X is a halogen such as F, Cl, Br or I and a is 0, 1, 2, 3 or 4. Examples of corrosive gases that can be purified by the devices and methods of the present invention include HCl, HBr, HF, F₂, Cl₂, Br₂, BCl₃ and ClF₃ as well as a number of silicon based compounds including SiCl₄, SiF₄, SiH₂Cl₂, SiHCl₃, CH₃SiH₂Cl, Cl₃Si—SiCl₃ and GeCl₄. The iodine-containing gases are also included within this invention, but in practice they are rarely used in manufacturing. It will also be understood that a process gas stream may contain a single halogen gas or mixtures of halogen gases, or may contain one or more halogen gases mixed with other, non-corrosive gases. Of course in any gas mixture, the gases must be compatible with and inert toward each other, except as may be required by the particular manufacturing process involved.

There are other halogen-containing gases which may also be of interest, particularly at elevated temperatures, such as chlorine oxides and chlorine-containing gases which are used to deposit less common elements in a gas- or vapor-deposition process. In addition, it is contemplated that the system may be useful with other gaseous chemicals which, in the presence of water, exhibit a “chlorine-like” corrosive nature (and therefore for the purpose of this invention will be considered to be equivalent to “chlorine-containing” gases).

It will be recognized that while the invention has been characterized in terms of use with gases for semiconductor and other electronic substrate manufacturing, it will be of similar value with respect to treatment of any corrosive halogen-containing or halide gases that are used for deposition of component materials for any other type of high purity product where moisture content is detrimental to the product's production. This could include, for instance, production of certain prosthetic devices for implant in humans or animals, production of high purity substrates, fiberoptic devices or other types of materials for research purposes, or production of high purity materials that are to be used in extreme environments such as products for use in spacecraft or artificial satellites.

One skilled in the art will readily understand that any of the standard methods for measuring impurity content in gases can be used.

For example, the moisture content of a sample can be measured using a Fourier Transform Infra Red (FT-IR) spectroscopy method described by D. E. Pivonka, 1991, Applied Spectroscopy, Vol. 45, Number 4, pp. 597-603, the relevant teachings of which are incorporated herein by reference. An example of a method for measuring moisture content is described below.

An FT-IR spectrometer equipped with an MCT (mercury cadmium tellurium alloy) detector can be used, for example the Nicolet Magna 760 FT-IR detector. The spectrometer was equipped with a 10 cm stainless steel cell in the auxiliary sample compartment for measurement of the water concentration at the inlet of the purifier, and a 10 m nickel-plated stainless steel cell for measurement of the water concentration downstream of the purifier. The water concentration of the inlet gas stream to the purifier, which is also referred to herein as the “moisture challenge,” is in the hundreds to thousands ppm range. The water concentration of the gas downstream of the purifier is typically in the range of 100 ppb-10 ppm. Dry conditions are maintained by a constant stream of purified nitrogen.

The “moisture challenge” gas stream, having a constant moisture concentration of about 400-500 ppm by volume can be generated as follows. Nitrogen is passed over a water diffusion vial held in a stainless steel autoclave at a constant temperature of 80° C., generating a moisture-containing nitrogen gas stream. The moisture-containing nitrogen gas stream is diluted with a stream of dry matrix gas (i.e., N₂, HCl or HBr), resulting in the “moisture challenge” gas stream. The accurate concentration of water in the moisture challenge gas stream is calculated based on the gas flow (through a calibrated mass-flow controller) and measuring the amount of water in the diffusion vial before and after the experiment. The “moisture challenge” gas stream is introduced into the purifier unit. Exemplary flow rate can be 2000 cc (STP) per min; exemplary pressure is 13.4 psia. The temperature of both the 10 cm and 10 m FT-IR cells is maintained at 110° C., and the mercury cadmium tellurium alloy detector is held at −190° C. The FT-IR measurement is based on the change in the water absorbance. The run is continued until a breakthrough occurred, meaning a sudden and drastic increase in water level downstream of the purifier. The breakthrough point is generally defined and calculated as the cross-section of the baseline representing moisture removal to the full efficiency of the purifier (usually, below the FT-IR detection limit, i.e., about 100 ppb) and the tangent of the breakthrough line showing a gradual increase in water level (as higher intensity absorbance). The transformation of the collected data and the breakthrough point into capacity terms as liter moisture (gas phase) per liter purifier, was done by straightforward arithmetic calculations.

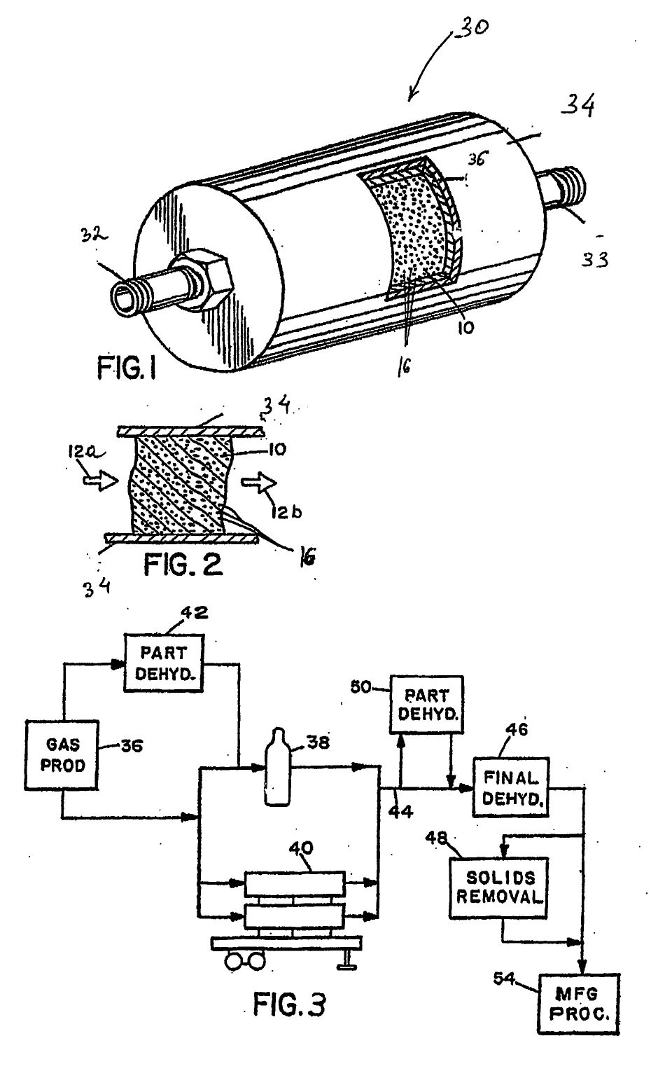

The zirconia-containing substrates can be used in a variety of different embodiments. As illustrated in FIG. 1 and FIG. 2, one can pass the gas through or over a body 10 consisting substantially or essentially of calcined or non-calcined zirconia itself or other purification, e.g., dehydration, substrates. Calcined zirconia is usually considered to have an active surface area of about 10-50 m²/g. That degree of active surface area is adequate for many purposes and is within the scope of the present invention. The inlet gas 12a has a moisture content normally >10 ppm and the outlet gas 12b has a moisture content of, in one embodiment, less than about 100 ppb, in another embodiment, less than 10 ppb. The illustration of FIG. 2 can also be considered to be a substrate body 10 having one or more pores 16 therethrough, so that the inlet gas 12a enters the pores of the solid and is dehydrated, exiting as outlet gas 12b with the requisite reduced moisture content.

In an embodiment of the invention, the zirconia can be MgO impregnated and calcined by heating to a temperature of between about 200 and 500° C. for a short period of time, sufficient to allow the zirconia to phase change (which usually occurs at about 350° C.-400° C.) and which produces a dense material with a surface area, as noted, of about 5-60 m²/g, with the surface area being inversely related to the temperature to which the zirconia is heated. Uncalcined zirconia which contains hydroxide (—OH) groups or a mixture of ZrOₓ with Zr(OH)₄ has a higher surface area when activated in the presence of hydrogen, approximately 150-300 m²/g and is preferred in the instant invention.

In one embodiment, the compounds of the invention can be activated, thereby allowing the use of non-calcined zirconia which is advantageous due to its substantially higher surface area as compared to high temperature-calcined zirconia. By way of example, the MgO-impregnated zirconia can be activated before use as a dehydrating agent. Briefly, the zirconia in a housing, container or other end use devices is exposed to a mixture of 95% argon (Ar)/5% hydrogen (H₂) at room temperature until the amount of water being released from the zirconia has reached a sufficiently low level and is preferably no longer detectable. This activation step increases the efficiency of the subsequent conditioning step (see Example 1).

One skilled in the art will understand that any activation procedure that reduces metal oxides (or hydrates) can be used. Activation can be performed at the temperature from about 150° C. to about 550° C. Activation can employ a number of reducing gases singularly, mixed, or in stepwise fashion, including but not limited to hydrogen, carbon monoxide, methane, and nitrous oxide. In most embodiments it is preferred to use a matrix gas that is inert, such as argon or nitrogen, as a diluent, because a large excess of the reducing gas is not required and increases the cost and safety hazard.

Upon delivery of the dehydrator to the end user, the dehydration substrate must be conditioned with the halogen or halide gas to be used in the dehydrator until the amount of water being released has dropped to an acceptable level. The level depends on both the source gas and the end use of the gas. Typically water should be less than about 100 ppb. The amount of time and purge gas required is dependent on a number of factors including flow rate and the amount of zirconia to be preconditioned. Determination of such parameters is well within the ability of those skilled in the art.

The activation step with hydrogen of the instant invention increases the utility of non-calcined zirconia which is advantageous due to its substantially higher surface area. Although the invention is not bound by mechanism of action, it is proposed that the step of conditioning with the halide results in the release of hydroxyl (OH) groups that would normally be driven off by heat when the zirconia is calcined at extreme temperatures. ZrO₂ in water has a mixed structure ZrOₓ(OH)_{y}, such as ZrO(OH)₂. When exposed to halide (e.g. HCl), the product is a mixed oxide/halide:
ZrO(OH)₂+HCl→ZrOCl₂+H₂O.
Therefore, initial exposure of the zirconia to halide results in an increase in the amount of water released from the dehydrator. It has been noted, that there is an increase in temperature to 90-100° C. outside the canister during the halide conditioning step, indicating a higher temperature inside the canister. This drives off any remaining water in the system resulting in an eventual decrease in the amount of water present.

A particularly advantageous aspect of the present invention is the ability to regenerate the purification material for reuse in the method described above. Regeneration according to the present invention comprises returning the purification material to a state in which a corrosive gas passed over or through the purification material is purified to contain less than 100 ppb, 50 ppb, 10 ppb, or 1 ppb impurities, wherein the preferred impurity removed is water. Regeneration further comprises returning the purification material to a state that has a total impurity capacity of not less than 80% of the original impurity capacity, preferably not less than 90% of the original capacity, wherein impurity capacity is defined as liters of impurity (in gas phase) removed per liter of purification material. It is preferred to measure the impurity capacity of the purification material with respect to removed water. The functional process of regeneration is similar to the process of activation in that it involves the partial reduction of the purification material followed by reconditioning the media with corrosive gas. Normally, the purification material comprising zirconia must first be deconditioned from the corrosive gas environment, i.e., halogen or halide species disposed therein is removed. As used herein, “deconditioning” means removing residual corrosive gas from the purification material. Deconditioning is optional in some embodiment. Any regeneration procedure that partially reduces the purification material and, thus, returns it to a state that is satisfactory for use in the method of the present invention can be used. A preferred regeneration procedure involves deconditioning the zirconia or doped zirconia purification material with nitrogen until the amount of corrosive gas exiting the purifier is within acceptable limits and subsequently introducing a mixture of 95% Ar/5% H₂ at temperature of about 200-500° C. for 1.5-4 hours. The purifier is purged with nitrogen until it returns to room temperature at which time it is ready for reuse.

Referring to FIG. 1, in the present invention it is most convenient to have the zirconia (doped or undoped) contained within a corrosion-resistant housing or canister 30. Typically, canister 30 includes gas ports 32 and 33 for attaching to gas flow lines. Typically, for flow lines for various common gas streams to be dehydrated, one will be dealing with gas flow rates in the range of about 1-300 standard liters of gas per minute (slm) and desired lifetimes in the range of 24 months. Operating temperatures of the gases may range from −80° C. to +100° C. and maximum inlet pressures to the canister 30 are commonly in the range of about 0 psig to 3000 psig (20,700 kPa). While any convenient container may be used, preferred are cylindrical canisters 30 with diameters in the range of about 3-12 in. (6-25 cm) and lengths of 4-24 in. (8-60 cm). The canister size will be dependent upon the gas flow rate and volume, the activity of the zirconia, and the amount of water to be removed, since it is necessary to have sufficient residence time in the device 30 to reduce the water content of the gas to or below 100 ppb.

The device of this invention can be used to provide final purification, e.g., dehydration, to gas streams intended for gas- or vapor-deposition formation of high purity electronic, prosthetic, fiber optic or similar products. Commonly, one may use a preliminary dehydration process upstream of a system of this invention, to reduce the water content of the gas stream to a level generally not lower than about 0.05 ppm, to maximize the efficiency and service life of the system of this invention. A solid particulate removal unit may also be placed upstream of the system of this invention, to remove particulate matter from the gas stream.

Also as illustrated in FIG. 3, it will be advantageous to use the process, material and equipment of the present invention in gas production facilities here the original high purity gases are produced for shipment to the ultimate product manufacturers. Commonly, halogen-containing gases in bulk are produced by the gas supply companies as at 36 and commonly then loaded into and shipped in familiar steel pressure cylinders 38 or tube trailers 40. This system can be modified by passing the produced gases through a system 42 of the present invention, but which is designed for only partial dehydration, before they are loaded into the cylinders 38 or tube trailers 40 for shipment to the customers. It will be understood that the volume of gas being transferred to the cylinders or trailers by the manufacturer is usually such that it is not economically justified to try to reduce the water content down to the final 100 ppb for delivery to the gas manufacturer's facility. Normally some water is likely to reenter the gas while being connected to the customer's gas supply systems. Also, dehydration to the final level for such a large volume of gas will take longer than is justified when filling large numbers of cylinders 38 or trailers 40. However, the value of usage of the system of this invention is that the cylinders 38 or tube trailers 40 of gas then arrive at, the ultimate manufacturers' facilities with a greatly reduced water content, such that they can be attached to the gas feed line 44 and passed through the dehydration unit 46 of the present invention for the final reduction to the water content needed for the production process 54, without requiring an intermediate water reduction step 50. (Such a step may be advantageously used, however, if the gas in cylinders 38 or trailers 40 has not had a prior partial drying in unit 42. Partial dehydration 50 may thus be an alternative to partial dehydration 42, to reduce the amount of water which must be removed in the final dehydration unit 46.)

It is also advantageous in most gas delivery systems to include a solids removal unit 48 as shown in FIG. 3, to eliminate any particulate matter which has entered from a cylinder 38 (or some other source). Such solids removal units are conventional, and will be of a type made of chlorine-corrosion-resistant materials.

Referring to FIG. 1, in one embodiment, canister 30 has a wall 34 made of stainless steel or other metal which is resistant to halogen corrosion. En another embodiment, the inside surface of wall 34 can be coated with a corrosion-resistant coating 36. In most cases these coatings will simply be inert materials which are resistant to corrosion by the specific material being dehydrated, but which do not contribute significantly to dehydration of the gas. However, it may be desirable to make the coating 36 on the inside of wall 34 of container 30 from zirconia, so that one can obtain dehydration along the walls of the container 30 in addition to the dehydration occurring at the zirconia bodies, coated substrates, coating porous bodies, etc. within the container itself.

### EXEMPLIFICATION

### Example 1

### Preparation of Zirconia for Use in the Present Invention

A preferred method for preparation of zirconia for use in the instant invention comprises:

1. Mixing Mg(OCOCH₃)₂ with ZrO₂ in water and allowing the insoluble magnesium impregnated zirconia to collect on a surface. ZrO contained about 1.5 wt. % hafnium and has a single point surface area of about 35 m²/g.

2. The magnesium-zirconium-water mixture is filtered, optionally pellitized, and the insoluble material is dried about 16-24 hours at about 150° C.

3. The material is then subjected to heating at about 300° C. for about 15 hours.

4. The material is then put into canisters or other end use devices.

5. The material is activated at about 200-500° C., preferably in 95% Ar/5% H₂, until the amount of moisture released drops to an acceptable level. This requires, typically, 1.5 to 4 hours. The end use device is shipped to the end user.

6. The device is conditioned with halide gas until the amount of moisture released drops to an acceptable level and the corresponding metal halide salt is formed and the dehydrator is ready for use.

While this invention has been particularly shown and described with references to preferred embodiments thereof, it will be understood by those skilled in the art that various changes in form and details may be made therein without departing from the scope of the invention encompasses by the appended claims.

1. A method of purifying a corrosive gas stream, comprising:
providing a purifier material comprising optionally doped zirconia; and
contacting the corrosive gas stream with the zirconia to remove an impurity from the corrosive gas stream.

2. The method of claim 1 wherein the impurity is water.

3. The method of claim 1 wherein the impurity is a volatile metal compound.

4. The method of claim 1 wherein the method produces a purified corrosive gas stream with an impurity level of not more than about 100 ppb.

5. The method of claim 1 wherein the purifier material has a surface area of not less than about 60 m2/g.

6. The method of claim 1 wherein the zirconia is doped with a non-zirconium additive.

7. The method of claim 6 wherein the non-zirconium additive comprises at least one of Ca, Mg, Si, Sc, Y, Hf, V, Nb, Ta, La, Ce, and Pr.

8. The method of claim 1, wherein the purifier material further comprises a metal oxide from at least one of Groups 1, 2, 3, 4, and 5.

9. The method of claim 8, wherein the metal oxide comprises a metal of at least one of Mg, Ca, Ba, Na, Li, K, V, Ta, Hf, Nb, Y, La and Ce.

10. The method of claim 9, wherein the metal oxide is MgO.

11. The method of claim 1 wherein the zirconia is not calcinated.

12. The method of claim 11 wherein the zirconia is activated by at least partially reducing the zirconia.

13. The method of claim 12 further comprising:
contacting the zirconia with a halogen-containing or halide gas before contacting the zirconia with the corrosive gas stream.

14. A method of removing water from a corrosive gas stream, comprising:
contacting the corrosive gas stream with a purifier material to remove water from the corrosive gas stream, the purifier material comprising optionally doped, uncalcinated zirconia activated with a reducing agent.

15. The method of claim 14 further comprising:
contacting the purifier material with a halogen-containing or halide gas, before contacting the corrosive gas stream with the purifier material.

16. The method of claim 15 wherein the purifier material further comprises MgO.

17. A method of regenerating a purifier material used to purify a corrosive gas stream, comprising:
providing the purifier material comprising optionally doped zirconia, the zirconia having contacted an impure corrosive gas; and
activating the purifier material by at least partially reducing the zirconia.

18. The method of claim 17 further comprising:
removing residual corrosive gas from the purifier material before activating the purifier material.

19. The method of claim 17 further comprising:
contacting the zirconia with a halogen-containing or halide gas, after activating the purifier material.

20. The method of claim 17, wherein activating the purifier material comprises contacting the zirconia with hydrogen gas.

21. A method of preparing a purifier, comprising:
providing the purifier material comprising optionally doped, uncalcinated zirconia;
activating the zirconia with a reducing agent; and
contacting the zirconia with a halogen-containing or halide gas.

22. The method of claim 21 wherein the zirconia is doped with a non-zirconium additive.

23. The method of claim 22 wherein the non-zirconium additive comprises at least one of Ca, Mg, Si, Sc, Y, Hf, V, Nb, Ta, La, Ce, and Pr.

24. The method of claim 21 wherein the purifier material further comprises a metal oxide from at least one of Groups 1, 2, 3, 4, and 5.

25. The method of claim 24 wherein the metal oxide comprises a metal of at least one of Mg, Ca, Ba, Na, Li, K, V, Ta, Hf, Nb, Y, La and Ce.

26. The method of claim 25 wherein the metal oxide is MgO.

27. The method of claim 21 wherein the purifier material has a surface area not less than about 60 m2/g.

28. A purifier material comprising:
optionally doped, uncalcinated zirconia activated with a reducing agent.

29. The purifier material of claim 28, wherein at least a portion of a surface of the zirconia is not bound with hydroxyl groups.

30. The purifier material of claim 28 wherein the zirconia is doped with a non zirconium additive.

31. The purifier material of claim 30 wherein the non-zirconium additive comprises at least one of Ca, Mg, Si, Sc, Y, Hf, V, Nb, Ta, La, Ce, and Pr.

32. The purifier material of claim 28 further comprising a metal oxide from at least one of Groups 1, 2, 3, 4, and 5.

33. The purifier material of claim 32 wherein the metal oxide comprises a metal of at least one of Mg, Ca, Ba, Na, Li, K, V, Ta, Hf, Nb, Y, La and Ce.

34. The purifier material of claim 33 wherein the metal oxide is MgO.

35. The purifier material of claim 28 wherein the purifier material has a surface area not less than about 60 m2/g.

36. A corrosive gas purifier, comprising:
a housing having an inlet port and an outlet port that are in fluid communication; and
a purifier material comprising optionally doped zirconia disposed within the housing, the zirconia and housing configured to contact a corrosive gas stream to be purified.

37. The corrosive gas purifier of claim 36 wherein the zirconia is doped with a non zirconium additive.

38. The corrosive gas purifier of claim 37 wherein the non-zirconium additive comprises at least one of Ca, Mg, Si, Sc, Y, Hf, V, Nb, Ta, La, Ce, and Pr.

39. The corrosive gas purifier of claim 36 further comprising a metal oxide from at least one of Groups 1, 2, 3, 4, and 5.

40. The corrosive gas purifier of claim 39 wherein the metal oxide comprises a metal of at least one of Mg, Ca, Ba, Na, Li, K, V, Ta, Hf, Nb, Y, La and Ce.

41. The corrosive gas purifier of claim 40 wherein the metal oxide is MgO.

42. The corrosive gas purifier of claim 36 wherein the zirconia is uncalcinated and activated with a reducing agent.

43. The corrosive gas purifier of claim 36 wherein the purifier material has a surface area of not less than about 60 m2/g.

44. The corrosive gas purifier of claim 36 wherein the housing has an inner surface coated with a corrosion-resistant coating.
